(19) United States
(12) Patent Application Publication
(10) Pub. No.: US 2010/0110433 A1
(43) Pub. Date: May 6, 2010

(54) Polarimetric imaging device optimized for polarization contrast

(75) Inventors: Alexandru Nedelcu, Bourg La Reine (FR); Philippe Bois, Cesson (FR); Eric Costard, Massy (FR)

Correspondence Address: LARIVIERE, GRUBMAN & PAYNE, LLP, 19 UPPER RAGSDALE DRIVE, SUITE 200, MONTEREY, CA, 93940, US

(73) Assignee: Thales, Neuilly sur Seine (FR)

(21) Appl. No.: 12/605,194

(22) Filed: Oct. 23, 2009

(30) Foreign Application Priority Data
Oct. 24, 2008 (FR) 08 05916

(51) Int. Cl. G01J 4/00

(52) U.S. Cl. 356/367

(57) ABSTRACT

The invention relates to a polarimetric imaging device comprising a multiple-quantum-well structure operating on inter-sub-band transitions by absorbing radiation at a wavelength λ, said structure comprising a matrix of individual detection pixels, characterized in that the matrix is organized in subsets of four individual pixels, a first pixel comprising a first diffraction grating (R_{P1}) sensitive to a first polarization, a second polarimetric pixel comprising a second diffraction grating (R_{P2}) sensitive to a second polarization orthogonal to the first polarization, a third polarimetric pixel comprising a third diffraction grating (R_{P3}) sensitive to a third polarization oriented at an angle between the first and second polarizations and a fourth pixel not comprising a polarization-selective diffraction rating (R_{2D}).

### PRIORITY CLAIM

This application claims priority to French Patent Application Number 08 05916, entitled Dispositif D'Imagerie Polarimetrique Optimise Par Rapport Au Contraste De Polarisation, filed on y Oct. 24, 2008.

### FIELD OF THE INVENTION

The field of the invention is that of electromagnetic wave detectors made of a semiconductor and notably to wave detectors having a multiple-quantum-well structure, particularly those suitable for the infrared range.

Rapid progress in epitaxial growth on GaAs-type substrates has resulted in the development of a new class of electromagnetic wave detectors using the absorption of radiation around a wavelength λ corresponding to the transition of electrons between various energy levels within the same energy band. The diagram in FIG. 1 illustrates this type of transition.

### BACKGROUND OF THE INVENTION

Recent advances in the performance of such components are due in particular to the relatively easy fabrication of semiconductor multilayer structures in the standard MBE (molecular beam epitaxy) system, i.e. the GaAs/Ga₍₁₋ₓ₎AlₓAs system. By adjusting the growth parameters, the thickness of the quantum wells and the fraction x of aluminium in the barriers imposing the confinement potential, a narrow detection band (about 1 micron in width) may be chosen to be centred on a given wavelength.

This type of structure has the advantage of providing very good sensitivity because of the discretization of the energy levels within the conduction bands of the photoconductive materials used.

Thus, multiple-quantum-well detectors are recognized as providing a very good technical solution for fabricating matrices sensitive to infrared radiation within the 8-12 μm band.

In the context of inter-sub-band transitions, in order for this type of transition to be possible it is necessary for the electric field of the incident electromagnetic wave to have a component along the growth direction of the layers (said direction being perpendicular to the plane of the layers). The consequence of this physical effect is that a detector exhibits little absorption in the case of illumination at normal incidence.

It has already been proposed to use coupling means of the diffraction grating type (cf. Goossen and Lyon, Appl. Phys. Lett. 47, 1257-1259 (1985)) for generating said perpendicular component by creating diffracted radiation. Thus, a diffraction grating operating in reflection may be etched on each pixel (the detectors are back-lit) as described in the article “Grating-coupled quantum-well infrared detectors: Theory and performance”, J. Y. Anderson and L. Lundqvist, J. Appl. Phys. 71, 3600 (1992) and illustrated in FIG. 2a, which demonstrates the use of arrays of studs for coupling the incident radiation whatever its polarization.

By replacing the two-dimensional matrix array of studs illustrated in FIG. 2a, commonly referred to as a “2-D” array, by a one-dimensional lamellar array illustrated in FIG. 2b, commonly called a “1-D” array, the coupling of the incident polarization perpendicular to the pattern is increased, as shown by the results in FIG. 2c, which show a curve 2c₁ and a curve 2c₂ relating respectively to the use of a 1-D array oriented as shown by the arrow 2b₁ in relation to a first polarization direction and to the use of a 1-D array oriented as shown by the arrow 2b₂ in relation to a second polarization direction orthogonal to the first direction. Thus, a pixel sensitive to the incident polarization is obtained.

Polarimetric imaging has the great advantage of allowing easier detection of manufactured objects, which may notably be of metallic type, in an observed scene and thus enable novel sources of contrast to be used under low thermal contrast conditions.

The principle of this type of detector has been demonstrated on pixels compatible with the fabrication of large-scale matrices (with a pattern period of less than 25 μm): “High contrast polarization sensitive quantum well infrared photodetectors”, T. Antoni, A. Nedelcu, X. Marcadet, H. Facoetti and V. Berger, Appl. Phys. Lett. 90, 201107 (2007).

It has also been shown that the relevant parameter for this type of system is the total signal contrast (I₁−I₂)/(I₁+I₂), where I₁ and I₂ are currents delivered by two pixels, the 1-D patterns of which are mutually orthogonal.

It has been found that the response of a polarimetric pixel is not perfectly polarized: there is no response for a polarization parallel to the 1-D lamellar pattern. This is due to a contribution to the optical coupling induced by the edges of the pixel which is equivalent to finite-size effects. This contribution is insensitive to the polarization.

A polarization-sensitive thermal imager has thus been developed by the company Thales Optronics Ltd., the focal plane of which is a multiple-quantum-well matrix commonly denoted by the acronym QWIP (quantum-well infrared photodetector) with a 20 μm pitch manufactured by ATL III-V Lab, as described in the article “Small pitch, large format long-wave infrared QWIP focal plane arrays for polarimetric imagery”, A. Nedelcu, H. Facoetti, E. Costard and P. Bois, SPIE 6542, 65420U (2007).

This imager has a monolithic structure integrating a matrix of detectors and a matrix of polarizers in the focal plane. It should be noted that in the infrared range, the QWIP technology is the only one to allow such integration.

This focal plane is constructed from an elementary cell consisting of 2×2 pixels, each having a differently oriented lamellar pattern, as illustrated in FIG. 3 which shows four types of different 1-D diffraction gratings R1, R2, R3 and R4. By combining the signals from the four pixels, it is possible to image the degree of linear polarization in the scene. To maintain image resolution, a microscanning system is used. Four video frames are necessary for constructing four images containing different polarimetric information. The active layer is optimized for operating at a high frame rate (200 Hz, with an integration time of 5 milliseconds), thereby allowing operation at a rate close to 50 Hz after processing.

The architecture described above nevertheless has a problem. This is because the response of each pixel is not perfectly polarized, this phenomenon being demonstrated in FIG. 2c, causing a reduction in the contrast compared with an ideal system.

### SUMMARY OF THE INVENTION

This is why the present invention provides a novel polarimetric imaging device architecture having a matrix focal plane comprising a sensitive layer based on multiple quantum wells and optical coupling means for carrying out the polarimetric imaging without significantly impairing the contrast.

More precisely, the subject of the present invention is a polarimetric imaging device comprising a multiple-quantum-well structure operating on inter-sub-band transitions by absorbing radiation at a wavelength λ, said structure comprising a matrix of individual detection pixels, characterized in that the matrix is organized in subsets of four individual pixels, a first polarimetric pixel comprising a first diffraction grating sensitive to a first polarization, a second polarimetric pixel comprising a second diffraction grating sensitive to a second polarization orthogonal to the first polarization, a third polarimetric pixel comprising a third diffraction grating sensitive to a third polarization oriented at an angle between the first and second polarizations and a fourth pixel not comprising a polarization-selective diffraction grating.

It should be noted that the response of the pixel with no grating is only due to the optical coupling via the edges of the pixel and is not sensitive to the polarization.

According to one embodiment of the invention, the fourth pixel does not comprise a diffraction grating.

According to one embodiment of the invention, the fourth pixel comprises a non-polarization-selective fourth diffraction grating.

According to one embodiment of the invention, the device further includes means for processing the signals recovered from the detection pixels.

According to one embodiment of the invention, the signal processing means comprise means for summing the signals coming from the first, second and third detection pixels respectively and means for subtracting the signal coming from the fourth detection pixel.

In this way, it is possible to obviate the unpolarized contribution of each pixel. This contribution contains the unpolarized optical signal (due to the coupling via the edges), but also the dark current.

It may be measured by means of the non-polarization-selective pixel and subtracted from the signal coming from the three other pixels.

According to one embodiment of the invention, the third pixel comprises a diffraction grating sensitive to a third polarization oriented at an angle of about 45°.

According to one embodiment of the invention, the first, second and third diffraction gratings are one-dimensional gratings having lamellar patterns.

According to one embodiment of the invention, the polarimetric imaging device comprises a multilayer stack produced on the surface of a substrate, said stack comprising the multiple-quantum-well structure and external layers, the lamellar patterns being etched within an external layer.

According to one embodiment of the invention, the multilayer stack is a stack of layers of the doped GaAs or InGaAs type (constituting the wells) and layers of the undoped AlGaAs or InAlAs type (constituting the barriers), the substrate being of the undoped GaAs or InP type.

According to one embodiment of the invention, the multiple-quantum-well structure is composed of an alternation of doped GaAs layers and undoped GaAlAs layers, the external layers being GaAs-based ohmic contact layers that are more highly doped than those making up the multiple-quantum-well structure.

According to one embodiment of the invention, the device of the invention comprises a substrate which is transparent at the wavelength of the incident radiation and a layer which is reflective at said wavelength, said reflective layer being on the surface of the diffraction gratings so as to make the detector operate in reflection.

Thus, according to the invention, the device of the invention makes it possible to carry out polarimetric imaging within the entire 3-20 μm infrared spectrum.

By subtracting the edge effects, the present invention makes it possible to increase the polarimetric contrast.

The invention will be better understood and other advantages will become apparent on reading the following description, given by way of non-limiting example, and thanks to the appended figures in which:

### LIST OF THE DRAWINGS

FIG. 1 illustrates a multiple-quantum-well structure according to the known art;

FIGS. 2a, 2b and 2c illustrate an imager structure comprising a 2-D array, an imager structure comprising a 1-D array and the variation in the spectral response of these two structures, respectively;

FIG. 3 illustrates a polarimetric imaging device comprising a QWIP multiple-quantum-well focal plane according to the prior art;

FIG. 4 illustrates a first example of an imaging device comprising a focal plane optimized for polarimetric contrast according to the invention;

FIG. 5 illustrates a second example of an imaging device comprising a focal plane optimized for polarimetric contrast according to the invention; and

FIG. 6 illustrates an embodiment of a focal plane used in an imager of the invention.

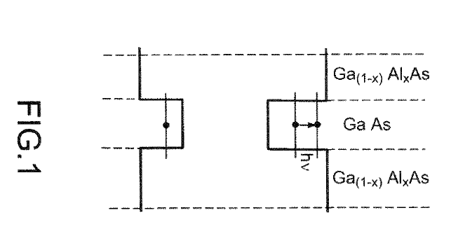

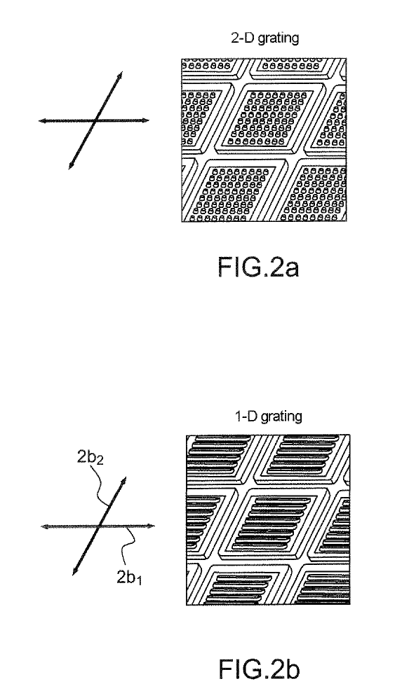

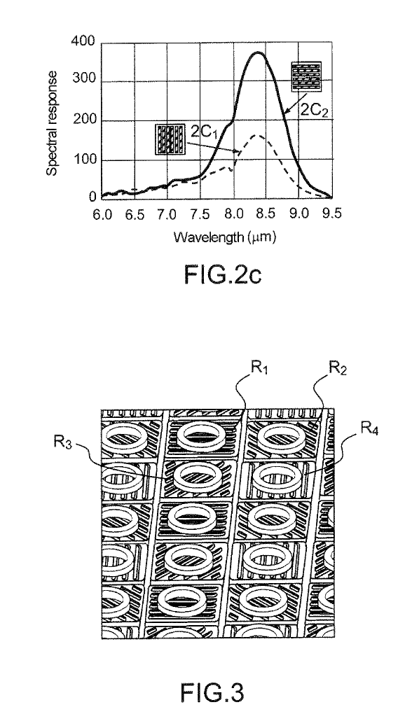

### DETAILED DESCRIPTION OF THE INVENTION

### First Example of an Imager According to the Invention

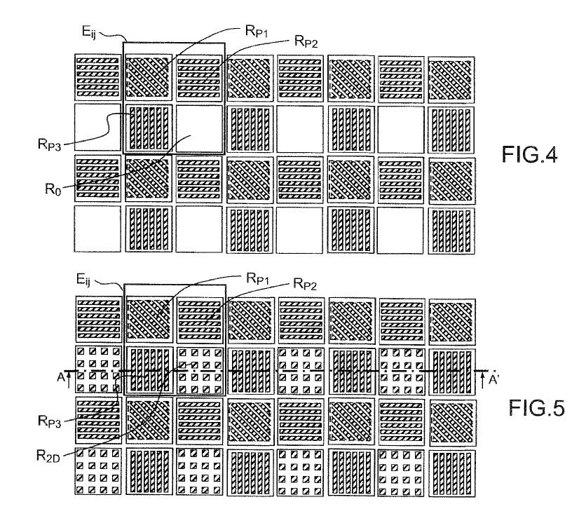

FIG. 4 illustrates a first example of the invention in which the imager comprises an MQW (multiple quantum well) structure comprising a set of detection elements at the surface of which selectively polarization-sensitive diffraction gratings have been produced. More precisely, this set of detection elements comprises subsets Eᵢⱼ consisting of four sub-pixels each respectively comprising a first 1-D diffraction grating sensitive to a first polarization R_{P1}, a second 1-D diffraction grating sensitive to a second polarization R_{P2}, a third 1-D diffraction grating sensitive to a third polarization R_{P3} and a fourth sub-pixel with no diffraction grating and referenced in the figure by R₀. Typically, the second polarization is orthogonal to the first, the third polarization making an angle of about 45° to the first. Advantageously, the imager further includes signal processing means for recovering high-quality polarimetric imaging information.

### Second Example of an Imager According to the Invention

FIG. 5 illustrates a second example of the invention in which the imager comprises an MQW (multiple quantum well) structure comprising a set of detection elements at the surface of which selectively polarization-sensitive diffraction gratings have been produced. More precisely, this set of detection elements comprises subsets consisting of four sub-pixels each respectively comprising a first 1-D diffraction grating sensitive to a first polarization R_{P1}, a second 1-D diffraction grating sensitive to a second polarization R_{P2}, a third 1-D diffraction grating sensitive to a third polarization R_{P3} and a fourth sub-pixel with for example a 2-D diffraction grating R_{2D} which is not wavelength-selective. The imager may advantageously also include signal processing means for recovering high-quality polarimetric imaging information.

As is known, the polarimetric imaging device of the invention may be produced on the surface of a substrate S made of a semiconductor. An assembly of layers is then produced on the surface of this semiconductor, said assembly constituting what is called a lower ohmic contact C₁ made of a highly doped semiconductor, which is deposited on the surface of the substrate. This ohmic contact supports all the semiconductor layers constituting the MQW structure.

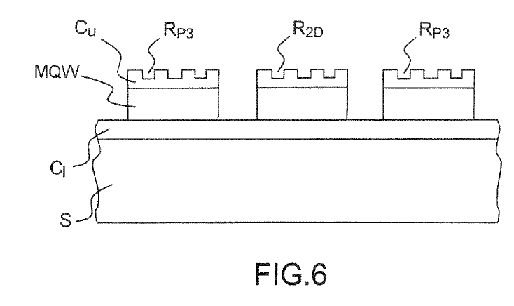

This structure is in contact with an assembly of layers constituting what is called an upper ohmic contact Cᵤ, detection taking place between the two ohmic contacts. Advantageously, the diffraction gratings made up of lamellar patterns may be etched in the upper ohmic contact layer as illustrated in FIG. 6, which shows a sectional view seen along the axis AA′ shown in FIG. 5.

### Embodiment of an Imager According to the Invention

We will now describe an embodiment of an imager according to the invention operating in the infrared range and more particularly suitable for the 8-12 micron range.

The lower ohmic contact layer made of Si-doped GaAs, with a level of doping of 1×10¹⁸ cm⁻³ and typically with a thickness of 2 microns, is deposited on a substrate made of undoped (intrinsic) GaAs.

The multiple-quantum-well structure is produced by stacking 50 wells made up of a silicon-doped GaAs layer with a charge carrier concentration of 2×10¹¹ cm⁻² and a 5 nm thickness inserted between two barrier layers made of Ga_{0.75}Al_{0.25}As of 50 nm thickness.

The upper contact layer is similar to the lower contact layer.

The lamellar patterns are produced within this upper contact layer.

To obtain the desired diffracting effects at an operating wavelength of 9 microns, the etching depths are 0.7 microns and the pitch of the patterns is 2.7 microns (the mean index of the structure being from 3.3 microns to 9 microns).

The fill factor of the surface of the upper contact layer is typically around 50%. The various diffraction gratings R_{P1}, R_{P2} and R_{P3} are produced by orienting the various lamellar patterns along a preferred direction.

1. Polarimetric imaging device comprising a multiple-quantum-well structure operating on inter-sub-band transitions by absorbing radiation at a wavelength λ, said structure comprising a matrix of individual detection pixels, wherein the matrix is organized in subsets of four individual pixels, a first polarimetric pixel comprising a first diffraction grating (R_{P1}) sensitive to a first polarization, a second polarimetric pixel comprising a second diffraction grating (R_{P2}) sensitive to a second polarization orthogonal to the first polarization, a third polarimetric pixel comprising a third diffraction grating (R_{P3}) sensitive to a third polarization oriented at an angle between the first and second polarizations and a fourth pixel not comprising a polarization-selective diffraction grating.

2. Polarimetric imaging device according to claim 1, wherein the fourth pixel does not comprise a diffraction grating.

3. Polarimetric imaging device according to claim 1, wherein the fourth pixel comprises a non-polarization-selective fourth diffraction grating (R_{2D}).

4. Polarimetric imaging device according to one of claims 1 to 2, including means for processing the signals recovered from the detection pixels.

5. Polarimetric imaging device according to claim 4, wherein the signal processing means comprise means for summing the signals coming from the first, second and third detection pixels respectively and means for subtracting the signal coming from the fourth detection pixel.

6. Polarimetric imaging device according to one of claims 1 to 2, wherein the third pixel comprises a diffraction grating sensitive to a third polarization oriented at an angle of about 45°.

7. Polarimetric imaging device according to one of claims 1 to 2, wherein the first, second and third diffraction gratings are one-dimensional gratings having lamellar patterns.

8. Polarimetric imaging device according to claim 7, comprising a multilayer stack produced on the surface of a substrate, said stack comprising the multiple-quantum-well structure and external layers, the lamellar patterns being etched within an external layer.

9. Polarimetric imaging device according to claim 8, wherein the multilayer stack is a stack of layers of the doped GaAs or InGaAs type (constituting the wells) and layers of the undoped AlGaAs or InAlAs type (constituting the barriers), the substrate being of the undoped GaAs or InP type.

10. Polarimetric imaging device according to claim 9, wherein the multiple-quantum-well structure is composed of an alternation of doped GaAs layers and undoped GaAlAs layers, the external layers being GaAs-based ohmic contact layers that are more highly doped than those making up the multiple-quantum-well structure.

11. Polarimetric imaging device according to one of claims 8 to 10, comprising a substrate which is transparent at the wavelength of the incident radiation and a layer which is reflective at said wavelength, said reflective layer being on the surface of the diffraction gratings, so as to make the detector operate in reflection.
